(19) United States
(12) Patent Application Publication
(10) Pub. No.: US 2023/0213276 A1
(43) Pub. Date: Jul. 6, 2023

(54) DEVICES, SYSTEMS, FACILITIES AND PROCESSES FOR CO2 CAPTURE/SEQUESTRATION AND CONVENTIONAL HYDROGEN GENERATION FROM BLAST FURNACE FACILITIES

(71) Applicant: NEXT CARBON SOLUTIONS, LLC, Houston, TX (US)

(72) Inventors: Vikrum Subra, Houston, TX (US); Ivan Van der Wait, Conroe, TX (US); Ben Heichelbech, Houston, TX (US)

(21) Appl. No.: 17/993,434

(22) Filed: Nov. 23, 2022

Related U.S. Application Data
(60) Provisional application No. 63/282,928, filed on Nov. 24, 2021.

(51) Int. Cl. F25J 1/02; F25J 1/00; C01B 32/50; B01D 53/04; B01D 53/14; F25J 3/08; B01D 53/34

(52) U.S. Cl. CPC F25J 1/0229; F25J 1/0027; C01B 32/50; B01D 53/0423; B01D 53/1475; F25J 1/0284; F25J 1/0283; F25J 1/0282; F25J 3/08; F25J 1/0262; B01D 53/343; C01B 2203/02; B01D 2257/504; F25J 2205/50; F25J 2220/60; F25J 2260/80; F25J 2290/62; F25J 2290/72; B01D 2256/16

(57) ABSTRACT

A blast furnace facility includes a process for capturing and sequestering CO2 generated from the facility process, generating hydrogen from hot blast furnace gas, and using blast furnace gas as methanol feed. The CO2 rich streams from the facility are sent to sequestration of some form via a sequestration compressor, thereby reducing the overall emissions from the facility. The other products generated by the facility are used as methanol feedstock and to produce hydrogen.

### CROSS REFERENCE TO RELATED APPLICATIONS

The present application claims the benefit of priority to U.S. Provisional Application No. 63/282,928 filed Nov. 24, 2021, the entirety of which is incorporated herein by reference.

### BACKGROUND

Blast furnace facilities contribute to greenhouse gases through the various processes. Greenhouse gases comprise various gaseous components such as carbon dioxide, methane, nitrous oxide, hydrofluorocarbons, perfluorocarbons, and sulfur hexafluoride that absorb radiation, trap heat in the atmosphere and generally contribute to undesirable environmental greenhouse effects.

Blast furnace facilities often implement certain forms of hydrocarbon reduction technologies such as scrubbers and flares, or reuse of the blast furnace gas as part of a combined cycle power plant. However, typically these facilities do not have a dedicated process specifically designed to reduce most greenhouse gas emissions.

Blast furnace facilities need to improve the overall efficiency of the facility and reduce greenhouse gas emissions.

### SUMMARY

A blast furnace facility may include several flue gas streams from various parts of the facility, each containing some concentration of CO2, which typically would be released to the atmosphere.

In a first aspect of the present disclosure, which may be combined with any other aspect listed herein unless specified otherwise, the blast furnace facility includes a duct firing system to increase the temperature and mass flow of the flue gas.

In a second aspect of the present disclosure, which may be combined with any other aspect listed herein unless specified otherwise, the flue gas from the duct firing system may be sent to a Heat Recovery Steam Generator (HRSG) unit configured to produce steam from the increased temperature and mass of the flue gas. The steam produced from the HRSG unit may be sent to a power generator to power the carbon and capture storage (CCS) facility users, with the excess power being sold to a power grid. Additionally, the steam may be sent to the CCS steam users, such as a regenerator reboiler, to be used in the process, and/or can be sent to the steam methane reformer (SMR) unit, and/or can be used for CCS facility power.

In a third aspect of the present disclosure, which may be combined with any other aspect listed herein unless specified otherwise, the flue gas from the HRSG unit may be sent to a heat exchanger to be cooled. In some examples, the heat exchanger is a gas/air heat exchanger that utilizes ambient air to cool the flue gas. Ambient air is provided from an air blower which may be electric or steam driven. The hot ambient air downstream of the exchanger is released to the atmosphere. In some embodiments, the heat exchanger is a direct contact cooler which uses water as the cooling medium to cool the flue gas from the HRSG.

In a fourth aspect of the present disclosure, which may be combined with any other aspect listed herein unless specified otherwise, the cooled flue gas from the heat exchanger may be sent to the CO2 absorber or capture unit. The CO2 absorber consists of a commercially available absorbing media for CO2, such as amine, ammonia, ionic fluids, sodium carbonate, methanol, potassium chloride, and any other industrially available solvents, and an absorber for absorbing CO2. The treated gas from, for example, the top of the absorber column is released to the atmosphere with less than 5% CO2 of the initial flue gas stream.

In a fifth aspect of the present disclosure, which may be combined with any other aspect listed herein unless specified otherwise, the rich solvent from the CO2 absorber may be sent to a regenerator to be processed. The lean solvent is sent back to the absorber for CO2 absorption. The CO2 rich gas stream from the regenerator may be further processed and sent to the sequestration compression unit and/or may be sent to a methanol feed header.

In a sixth aspect of the present disclosure, which may be combined with any other aspect listed herein unless specified otherwise, the sequestration compression unit includes an electric, steam, supercritical CO2, or gas driven sequestration compressor configured to compresses the CO2 rich gas stream, which then may be transported via pipeline, truck, train, or rail.

In a seventh aspect of the present disclosure, which may be combined with any other aspect listed herein unless specified otherwise, the CO2 is transported to a sequestration site either on land, sea, in a geological formation containing a saline aquifer, or to be used for enhanced oil recovery.

In an eighth aspect of the present disclosure, which may be combined with any other aspect listed herein unless specified otherwise, the CO2 can be transported as a feedstock for other industrial users.

In a ninth aspect of the present disclosure, which may be combined with any other aspect listed herein unless specified otherwise, the CO2 can be sent to a storage tank to be combined with aggregate CO2, to be used in syngas production, or to be used in power production. For power production, the liquid CO2 which is stored can act as a “peak shaving” facility and evaporate the liquid CO2 as power is required. This liquid CO2 is expanded into gas to drive a set of turbines to generate electricity. The gas is returned to a dome to be stored and compressed into liquid to start the cycle again.

In a tenth aspect of the present disclosure, which may be combined with any other aspect listed herein unless specified otherwise, hot gas from the blast furnace exhaust is sent to as separate blast furnace HRSG unit configured to produce steam that may be sent to the SMR unit.

In an eleventh aspect of the present disclosure, which may be combined with any other aspect listed herein unless specified otherwise, the cooled gas from the blast furnace HRSG may be sent to plant and CCS heat users.

In a twelfth aspect of the present disclosure, which may be combined with any other aspect listed herein unless specified otherwise, the blast furnace gas from the plant users may be sent to the methanol feed header. The blast furnace gas contains hydrogen, carbon monoxide, and carbon dioxide, which are the constituents of methanol feed gas.

In a thirteenth aspect of the present disclosure, which may be combined with any other aspect listed herein unless specified otherwise, the SMR unit produces hydrogen from feed gas and the steam generated by the blast furnace HRSG unit.

In a fourteenth aspect of the present disclosure, which may be combined with any other aspect listed herein unless specified otherwise, the hydrogen produced at the SMR unit may be sent to transport for market, such as via pipeline, rail, truck, and ship, and/or sent to the methanol feed header.

In a fifteenth aspect of the present disclosure, which may be combined with any other aspect listed herein unless specified otherwise, the CO2 generated by the SMR unit may be sent to the inlet of the heat exchanger. Additionally, this CO2 can be sent to a separate cooler and then sent to the inlet of the CO2 absorber.

In a sixteenth aspect of the present disclosure, which may be combined with any other aspect listed herein unless specified otherwise, the feedstock at the methanol feed header which consists of H2, CO and CO2, may be sent to transport via pipeline, rail, truck, and ship to a methanol facility as feed.

Additional features and advantages of the disclosed devices, systems, and methods are described in and will be apparent from the following Detailed Description and the Figures. The features and advantages described herein are not all-inclusive and in particular many additional features and advantages will be apparent to one of ordinary skill in the art in view of the figures and description. Also, any particular embodiment does not have to have all of the advantages listed herein. Moreover, it should be noted that the language used in the specification has been principally selected for readability and instructional purposes, and not to limit the scope of the inventive subject matter.

### BRIEF DESCRIPTION OF THE FIGURES

Understanding that the figures depict only typical embodiments of the invention and are not to be considered to be limiting the scope of the present disclosure, the present disclosure is described and explained with additional specificity and detail through the use of the accompanying FIGURE.

FIG. 1 illustrates an exemplary schematic of a blast furnace facility configured to send flue gas to sequestration/storage.

### DETAILED DESCRIPTION OF EXAMPLE EMBODIMENTS

The detailed description is to be construed as exemplary only and does not describe every possible embodiment, as describing every possible embodiment would be impractical, if not impossible. One of ordinary skill in the art could implement numerous alternate embodiments, which would still fall within the scope of the claims. To the extent that any term is referred to in a manner consistent with a single meaning, that is done for the sake of clarity and illustration only, and it is not intended that such claim term be limited to that single meaning.

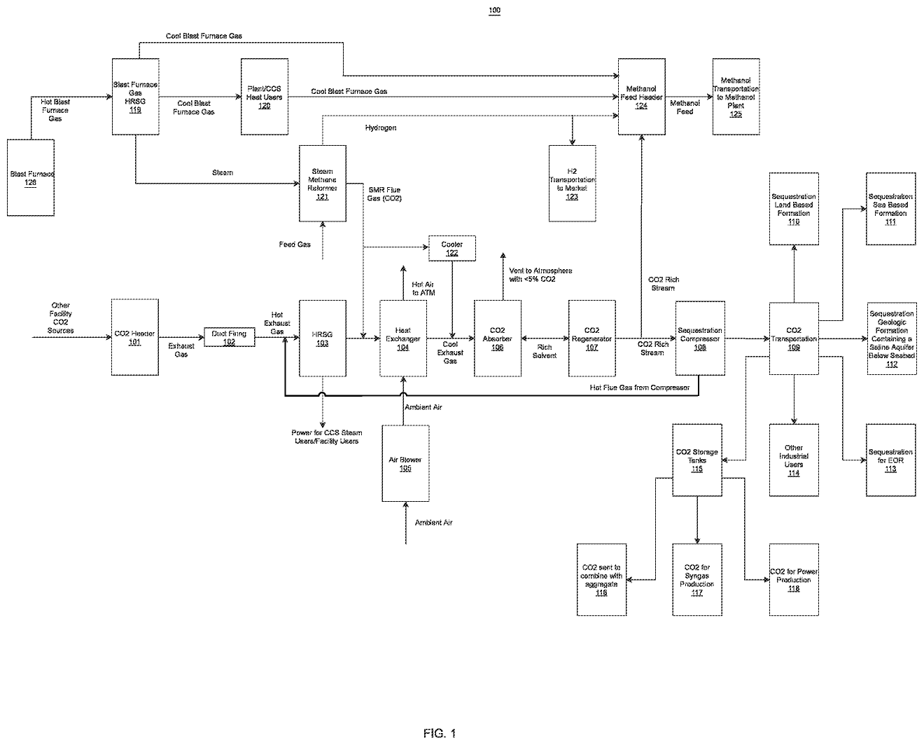

FIG. 1 illustrates an exemplary schematic of a blast furnace facility 100 with flue gas from the facility being sent to sequestration, storage, out for methanol production, and/or to market.

Blast furnace plant CO2 sources including the emissions from the blast furnace 126 outside of the hot blast furnace gas may be directed to the CO2 header 101. As used in this specification, the term “Blast Furnace Plant CO2 Sources” includes any and/or all the CO2 sources from the plant except the blast furnace gas. The gas may be combined in the CO2 header 101 and sent to duct firing 102, where the temperature and mass flow of the flue gas is increased. The flue gas may then be sent to a Heat Recovery Steam Generator (HRSG) unit 103, which may generate synchronous power for the power grid and/or steam for the carbon capture and storage (CCS) facility users.

The flue gas from the HRSG unit 103 may be sent to a heat exchanger 104 to reduce the temperature prior to CO2 absorption. In some embodiments, the heat exchanger 104 may be a gas/air heat exchanger, and air may be provided by an electric or steam driven air blower 105, which may be sized accordingly to blow ambient air through the heat exchanger 104. Hot ambient air may be released to the atmosphere. In some embodiments, the heat exchanger 104 may be a direct contact cooler which uses water as the cooling medium to cool the flue gas from the HRSG unit 103.

Cooled flue gas from the heat exchanger 104 may be sent to a CO2 absorber 106, where the CO2 may be absorbed through a commercially available absorbent media. Examples of absorbing media include amine, ammonia, ionic fluids, sodium carbonate, methanol, potassium chloride, and/or any other available industrial solvents. The treated gas containing less than about 5% CO2 may be vented to the atmosphere. This CO2 absorber may be designed to achieve about 50% turndown capacity while still achieving a capture rate of about 95%.

The flue gas and the rich solvent-containing CO2 gas may be sent to the CO2 regenerator 107, where CO2 may be removed from the rich solvent-containing CO2 using heat or another form of energy, creating a lean solvent which may then be returned to the CO2 absorber 106.

The CO2 rich gas from the CO2 regenerator 107 may be sent to a sequestration compressor unit 108 and/or to the methanol feed header 124. The sequestration compression unit 108 may include one or more knockout drums for collecting any remaining liquid in the gas stream and at least one compressor that is steam, electric or natural gas driven configured to compress the carbon dioxide rich stream. This sequestration compressor may be designed to achieve about 50% turndown capacity while still sequestering the full amount of CO2. When the compressor is driven by a natural gas fired compressor the flue gas from the compressor may be returned to the HRSG 103 to make use of the heat in the flue gas and begin the capture of the CO2 from the compressor flue gas stream.

The compressed CO2 rich stream may be sent to CO2 transportation 109 (pipeline, truck, rail, ship, etc.) and then to off-site sequestration. The offsite sequestration may be storage in a land based formation 110, in a sea based formation 111, in a geological formation containing a saline aquifer below the seabed 112, or in a partially depleted hydrocarbon reservoir for enhance oil recovery (EOR) 113. For example, the sequestration site may be a region below a seabed, wherein the seabed is located at a depth greater than about 3.0 kilometers below sea level. Furthermore, the compressed CO2 may be sent to other industrial users 114 for feedstock. If the CO2 is sent to storage tanks 115, it can be further combined with aggregate CO2 for other uses 116, used for syngas production 117, and/or to be used in power production 118. For power production, the liquid CO2 which is stored can act as a “peak shaving” facility and evaporate the liquid CO2 as power is required. This liquid CO2 is expanded into gas to drive a set of turbines to generate electricity. The gas is returned to a dome to be stored and compressed into liquid to start the cycle again.

As shown in FIG. 1, the hot blast furnace gas from the from the blast furnace 126 may be sent to a separate blast furnace gas HRSG unit 119 in order to generate steam. The steam from the HRSG unit 119 along with feed gas may be sent to the Steam Methane Reformer (SMR) 121 that utilizes conventional methods to generate hydrogen. The CO2 flue gas produced from the SMR 121 may be sent to a tie-in at the inlet of the gas-air heat exchanger 104 and/or a cooler 122 prior to tying in downstream of the gas-air heat exchanger 104. The hydrogen produced at the SMR 122 may then be sent to transportation to market 123 (for example, at least one of pipeline, truck, rail, ship, etc.) and/or to the methanol feed header 124.

The blast furnace gas from the blast furnace HRSG 119 may be sent to other units such as plant/CCS heat users/cooler 120 to utilize some of the excess heat or directly to the methanol feed header 124, as it contains mostly of hydrogen, carbon monoxide, and carbon dioxide, which are the constituents of methanol feed gas. The methanol feed gas from the methanol feed header 124 may be sent to methanol transportation 125, which ultimately may be sent to a methanol plant as feed.

The system 100 may also include ancillary heating equipment that may run full time to support the heating requirements of the carbon capture facility. This support may be needed in order to handle about 0-50% turndown with a low capture yield and a fast response on increased capture rate when the system is ramped up.

By sending the carbon dioxide rich stream to some form of sequestration and utilizing the blast furnace gas and hydrogen production to make high value products such as methanol, overall greenhouse gas emissions from facility 100 are reduced.

All percentages expressed herein are by weight of the total weight of the composition unless expressed otherwise. As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in this disclosure and the appended claims, the singular forms “a,” “an” and “the” include plural referents unless the context clearly dictates otherwise. Thus, for example, reference to “an ingredient or “the ingredient” means “at least one ingredient” and includes two or more ingredients.

The words “comprise,” “comprises” and “comprising” are to be interpreted inclusively rather than exclusively. Likewise, the terms “include,” “including” and “or” should all be construed to be inclusive, unless such a construction is clearly prohibited from the context. Nevertheless, the compositions disclosed herein may lack any element that is not specifically disclosed herein. Thus, a disclosure of an embodiment using the term “comprising” includes a disclosure of embodiments “consisting essentially of” and “consisting of” the components identified. A composition “consisting essentially of” contains at least 75 wt. % of the referenced components, preferably at least 85 wt. % of the referenced components, more preferably at least 95 wt. % of the referenced components, most preferably at least 98 wt. % of the referenced components.

The terms “at least one of” and “and/or” used in the respective context of “at least one of X or Y” and “X and/or Y” should be interpreted as “X,” or “Y,” or “X and Y.” For example, “at least one of honey or chicory root syrup” should be interpreted as “honey without chicory root syrup,” or “chicory root syrup without honey,” or “both honey and chicory root syrup.”

Where used herein, the terms “example” and “such as,” particularly when followed by a listing of terms, are merely exemplary and illustrative and should not be deemed to be exclusive or comprehensive.

The many features and advantages of the present disclosure are apparent from the written description, and thus, the appended claims are intended to cover all such features and advantages of disclosure. Further, since numerous modification and changes will readily occur to those skilled in the art, the present disclosure is not limited to the exact construction and operation as illustrated and described. Therefore, the described embodiments should be taken as illustrative and not restrictive, and the disclosure should not be limited to the details given herein but should be defined by the following claims and their full scope of equivalents, whether foreseeable or unforeseeable no or in the future.

We claim:

1. A system for treating, compressing, and sequestering carbon dioxide (CO2) derived from flue gas of a blast furnace facility, generating hydrogen from hot blast furnace gas, and using blast furnace gas as methanol feed, the system comprising:
a flue gas Heat Recovery Steam Generator (HRSG) unit configured to receive the flue gas from process units of the blast furnace facility and to generate steam;
a heat exchanger configured to cool the flue gas from the HRSG unit using ambient air from an air blower;
a CO2 absorber configured to receive the flue gas from the heat exchanger and to remove CO2 from the flue gas, the CO2 absorber including an absorbent for absorbing CO2 from the flue gas;
a sequestration compression unit configured to compress the flue gas into compressed CO2 rich stream and to convey the compressed CO2 rich stream towards at least one of a sequestration site, a storage tank, or an industrial user, the sequestration compression unit comprising a sequestration compressor that is one of electric driven, steam driven, or supercritical CO2 driven;
a blast furnace HRSG unit configured to receive the blast furnace gas and to generate steam;
a steam methane reformer (SMR) unit configured to produce hydrogen from the steam from the blast furnace HRSG unit and a feed gas, the SMR unit being configured to direct SMR flue gas to a tie-in upstream of the gas-air heat exchanger;
a methanol feed header configured to receive the blast furnace gas from the blast furnace HRSG unit, the hydrogen from the SMR unit, and the flue gas supplied from downstream of a CO2 regenerator.

2. The system of claim 1, further comprising a duct firing unit configured to receive the flue gas from process units of the blast furnace facility, wherein the duct firing unit is configured to increase a temperature and a mass flow of the flue gas.

3. The system of claim 1, wherein the heat exchanger comprises a gas/air heat exchanger configured to utilize ambient air to cool the flue gas.

4. The system of claim 1, wherein the heat exchanger comprises a direct contact cooler configured to utilize water to cool the flue gas.

5. The system of claim 1, wherein the HRSG unit is configured to direct the steam to a power generator or a power grid.

6. The system of claim 1 comprising a cooler configured to receive the SMR flue gas from the SMR unit, and the cooler is positioned upstream of a tie-in between the heat exchanger and the CO2 absorber.

7. The system of claim 1, wherein the sequestration compressor unit comprises a gas driven compressor, and the system is configured to direct exhaust gas from the gas driven compressor to a tie-in upstream of the HRSG unit.

8. The system of claim 1, wherein the sequestration site is selected from the group consisting of a land based geological formation, a region on top of a seabed. a region below a seabed, a region in a geological formation containing a saline aquifer below the seabed, existing wells for enhanced oil recovery (EOR), and combinations thereof.

9. The system of claim 1, wherein the system is configured to transport a further CO2 rich stream from the sequestration compressor unit to an industrial user.

10. A process for treating, compressing, and sequestering carbon dioxide (CO2) derived from flue gas of a blast furnace facility, generating hydrogen from hot blast furnace gas, and using blast furnace gas as methanol feed, the process comprising:
receiving, at a Heat Recovery Steam Generator (HRSG) unit, the flue gas from process units of the blast furnace facility and generating steam;
cooling, at a heat exchanger, the flue gas from the HRSG unit;
absorbing, at a CO2 absorber, CO2 from the flue gas;
compressing, at a sequestration compression unit, the flue gas;
conveying, by the sequestration compression unit, the compressed flue gas towards at least one of a sequestration site, a storage tank, or an industrial user;
receiving, at a blast furnace HRSG unit, the blast furnace gas and generating steam;
producing, at a steam methane reformer (SMR) unit, hydrogen from the steam from the blast furnace HRSG unit and a feed gas;
receiving, at a methanol feed header, the blast furnace gas from the blast furnace HRSG unit, the hydrogen from the SMR unit, and the flue gas from downstream of a CO2 regenerator.

11. The process of claim 10 comprising receiving, at a duct firing unit, the flue gas from the process units of the blast furnace facility, wherein the duct firing unit is configured to increase a temperature and a mass flow of the flue gas.

12. The process of claim 10, wherein the heat exchanger is a gas/air heat exchanger, and the process comprises the gas/air heat exchanger using ambient air as a cooling medium.

13. The process of claim 10, wherein the heat exchanger is a direct contact cooler, and the process comprises the direct contact cooler using water as a cooling medium.

14. The process of claim 10, wherein the sequestration compression unit comprises a sequestration compressor, the sequestration compressor is gas driven, and the process comprises directing exhaust gas from the sequestration compressor directly or indirectly to the HRSG unit.

15. The process of claim 10, further comprising utilizing, by a power generator, steam generated by the HRSG unit to provide power and/or sell power to a power grid.

16. The process of claim 10, wherein the sequestration site is selected from the group consisting of a region on top of a seabed and located at a depth greater than about 3.0 kilometers below a sea level, a region below a seabed, a region in a geological formation containing a saline aquifer below the seabed, existing wells for enhanced oil recovery, and combinations thereof.

17. The process of claim 10, further comprising receiving, by a cooler, SMR flue gas from the SMR unit and cooling the SMR flue gas, the cooler positioned upstream of a tie-in between the heat exchanger and the CO2 absorber.

18. A process for treating, compressing, and sequestering carbon dioxide (CO2) derived from flue gas of a blast furnace facility, generating hydrogen from hot blast furnace gas, and using blast furnace gas as methanol feed, the process comprising:
cooling, at a heat exchanger, the flue gas directly or indirectly from process units of the blast furnace facility;
absorbing, at a CO2 absorber, CO2 from the flue gas;
compressing, at a sequestration compression unit, the flue gas;
conveying, by the sequestration compression unit, the compressed flue gas towards at least one of a sequestration site, a storage tank, or an industrial user;
receiving, at a blast furnace HRSG unit, the blast furnace gas and generating steam;
producing, at a steam methane reformer (SMR) unit, hydrogen from the steam from the blast furnace HRSG unit and a feed gas;
receiving, at a methanol feed header, the blast furnace gas from the blast furnace HRSG unit, the hydrogen from the SMR unit, and the flue gas directly or indirectly from the CO2 absorber.

19. The process of claim 18, conveying, by the methanol feed header, methanol feed gas to a methanol plant, the methanol feed gas comprising the blast furnace gas, the hydrogen, and the flue gas.

20. The process of claim 18, wherein the heat exchanger is a gas/air heat exchanger, and the process comprises the gas/air heat exchanger using ambient air as a cooling medium.

21. The process of claim 18, wherein the heat exchanger is a direct contact cooler, and the process comprises the direct contact cooler using water as a cooling medium.

22. The process of claim 18, wherein the sequestration compression unit comprises a sequestration compressor, the sequestration compressor is gas driven, and the process comprises directing exhaust gas from the sequestration compressor directly or indirectly to the HRSG unit.

23. The process of claim 18, wherein the sequestration site is selected from the group consisting of a region on top of a seabed and located at a depth greater than about 3.0 kilometers below a sea level, a region below a seabed, a region in a geological formation containing a saline aquifer below the seabed, existing wells for enhanced oil recovery, and combinations thereof.
